(19) United States
(12) Patent Application Publication
(10) Pub. No.: US 2026/0098684 A1
(43) Pub. Date: Apr. 9, 2026

(54) SUPPORT UNIT FOR A CARRIER PLATE FOR THE CONSTRUCTION OF A TIERED RACK, TIERED UNIT WITH SUPPORT UNITS OF THIS TYPE AND TIERED RACK FOR THE HEAT TREATMENT OF WORKPIECES

(71) Applicant: ONEJOON GMBH, Bovenden (DE)

(72) Inventor: Arian Esfehanian, Böblingen (DE)

(21) Appl. No.: 19/113,105

(22) PCT Filed: Sep. 1, 2023
(86) PCT No.: PCT/EP2023/074076

§ 371 Date: Mar. 19, 2025

(30) Foreign Application Priority Data
Sep. 22, 2022 (DE) 10 2022 124 350.8

(51) Int. Cl. F27B 9/24; F27D 3/00; F27D 5/00

(52) U.S. Cl. CPC F27B 9/24; F27D 5/0006; F27D 2003/0051

(57) ABSTRACT

A conveying device for conveying material, in particular material having a temperature of 1500° C. to 3200° C., in particular for conveying thermally or thermo-chemically treated material, has a housing which has a material inlet and a material outlet The material can be conveyed from the material inlet to the material outlet along a conveying path by means of a conveying device Along the conveying path such surfaces that come into contact with the material to be conveyed are provided, at least in certain areas, by a material that is a graphite material or a material with graphite-like properties.

### BACKGROUND OF THE INVENTION

### 1. Field of the Invention

The invention relates to a support unit for a carrier plate for the construction of a tiered rack for the heat treatment of workpieces, wherein the carrier plate along with multiple support units forms a tiered unit and has multiple plate through-openings, wherein in each case a support unit can be connected there to the carrier plate there in such a way that the carrier plate carries the respective support unit along during a movement, with
a) a plug element with a head section which cannot pass through the plate through-opening due to its shape, and with a shaft section projecting from the head section which is complementary to the plate through-opening in such a way that it can pass therethrough and which has a bottom end at a distance from the head section;
b) a support element that is connected to the bottom end of the shaft section; wherein
c) in a functional configuration of the support unit, between the head section of the plug element and the support element, a spacing and a receiving region remain in which the carrier plate can be arranged between the head section and the support element or where it is arranged in a tiered unit.

The invention also relates to a tiered unit for the construction of a tiered rack for the heat treatment of workpieces, which comprises a carrier plate with multiple of plate through-openings, wherein in each case one support unit is connected to the carrier plate there in such a way that the carrier plate carries the respective support unit along in the event a movement.

Furthermore, the invention relates to a tiered rack for the heat treatment of workpieces, which comprises multiple tiered units each having one carrier plate and multiple support units.

### 2. Description of the Prior Art

During the heat treatment of workpieces, in particular at temperatures above 1,000 ° C., the workpieces are often placed on tiered racks with ceramic carrier plates in multiple tiers and then treated in an adequate kiln. The ceramic carrier plates are usually made of silicon carbide SiC, but can also be made of other materials such as graphite, cordierite, mullite, etc.

In order for the carrier plates to be stacked on top of each other, each plate must stand on three or more support units of the type mentioned at the beginning, which are usually also ceramic and made of the materials mentioned above, since metals cannot be used at the high temperatures. In the past, corresponding tiered racks were manually assembled by workers when loading a furnace and then dismantled again when it was emptied.

However, the processes and in particular the loading of a heat treatment furnace before the heat treatment and its emptying thereafter are now mostly automated with the help of handling robots. For this purpose, the support units are non-movably connected to the carrier plate, namely at each place where a plate through-opening in the carrier plate is present. The carrier plate then forms a tiered unit with the associated support units, which can be gripped and moved as a whole by a handling robot.

In a tiered rack, successive support units are then arranged vertically along a longitudinal axis. Usually, the support element of a support unit rests on the head section of the plug element of the support unit below.

In the case of support units of the aforementioned type that are known from the market, the head section of the plug element and the support element clamp the carrier plate between them in the above-mentioned functional configuration. The term functional configuration defines the configuration that the support unit and its plug element and support element assume and also need to maintain during use.

In the case of known support units, the plug element and the support element are immovable in this functional configuration, both in relation to each other and in relation to the carrier plate.

For this purpose, the plug element and the support element are usually screwed together. For example, a plug element has an external thread at its bottom end and is inserted from above through a plate through-opening. The support element has a complementary internal thread in its coupling region and is screwed to the plug element from below.

Regardless of the specific type of connection, the support units are positionally fixed in relation to the carrier plate. From this, and specifically from the screw connection of the plug element and the support element, several problematic aspects are apparent.

First of all, in the case of multiple tiered units needed for a tiered rack, it is already a challenge to position the support units in such a way that each of the vertically successive support units are aligned and that there are no offsets in the radial direction that prevent the tiered units from being stacked precisely on top of each other. Such offset problems can be caused, for example, by the structural tolerances in the length and width of the carrier plate, in the positions and diameters of the plate through-openings, and in the diameters of the plug and support elements.

In addition, the plug element and the support element are subjected to shear stresses that occur due to lateral plate movements, which are already caused by thermal expansion. With known support units, this regularly results in breakage, in particular of the plug element of the support unit.

Furthermore, it can occur during operation that the plug element and the support element leave the functional configuration, for example if the screw connection loosens. In this case, however, the load is no longer absorbed by the support element but is transferred downwards via the screw thread. If tensile, shear or compression stresses occur, this can easily lead to breakage.

Even with functionally correct clamping, small gaps remain between the carrier plate and the head section of the plug element or the support element. There, and also in the plate through-opening, powder from ceramic abrasion can accumulate, which can then cause local melting phases during subsequent heat treatments, which then lead to rigid bonding of the components to the carrier plate during cooling.

It is now the object of the invention to provide a support device, a tiered unit, and a tiered rack of the aforementioned type which take these ideas into account.

### SUMMARY OF THE INVENTION

This object is achieved with a support unit of the aforementioned type in that
d) in the unloaded functional configuration of the support unit, the plug element and the support element are movable relative to one another and/or relative to the carrier plate in the case of a tiered unit.

The support unit is present in such an unloaded functional configuration when, for example, a separated tiered unit is moved by a handling robot that engages on the carrier plate for this purpose. In such a design of the support unit, the carrier plate is not clamped between the head section of the plug element and the support element, while it is still ensured that the support element can absorb the load and the support unit as such is carried along during a movement of the tiered unit. A screw connection can still be formed between the plug element and the support element, but the load is prevented from being absorbed by the screw connection. If powder gets into the regions between the carrier plate and the support unit, it can be removed more easily if necessary, preventing the components from sticking together. Details of such functional configurations are apparent from in the description of the exemplary embodiments below.

The plug element can basically be in one piece. However, it is also advantageous if the head section of the plug element is designed as a separate head section and the shaft section as a shaft section, which are detachably connected to one another by means of a connection, in particular by means of a threaded connection. As can be seen below from the description of the exemplary embodiments, this opens up additional possibilities when assembling a tiered unit.

In one variant, the shaft part is designed as a separate shaft part that is also detachably connected to the support element.

It is then particularly advantageous if the support element is a support sleeve. A sleeve always has a through-channel and, in particular, can be designed as a hollow cylinder with a constant or stepped inner cross-section. The outer cross-section and the inner cross-section can be, but do not have to be, circular. In any case, the carrier plate can rest properly on the end face of a support sleeve, while the plug part protrudes into the interior of the support sleeve.

To ensure that the plug element and the support element do not lose their connection to each other in the unloaded functional configuration, it is advantageous if the support element has a counter device that cooperates with the bottom end of the plug element in such a way that the bottom end of the plug element carries the support element along during movement.

In conjunction with a support sleeve, the following alternatives are particularly preferred, in which
a) the plug element carries at its bottom end at least two coupling pins projecting transverse to its longitudinal axis, wherein
   aa) the counter device of the support sleeve comprises counter ribs matching the coupling pins of the plug element, which counter ribs project inwards on the inner shell surface of the support sleeve and are spaced apart in the circumferential direction in such a manner that the coupling pins of the plug element can be passed through between the counter ribs;
      or
   ab) the counter device of the support sleeve comprises guide slots or guide grooves which are complementary to the coupling pins of the plug element and extend in the wall of the support sleeve from an open end to a stop end and in which the coupling pins of the plug element are guided;
      or
b) the plug element forms a coupling collar, in particular a coupling cone, at its bottom end and the counter device of the support sleeve is formed by a step complementary to the coupling collar and having a downwardly facing step surface in the inner shell surface of the support sleeve.

Particularly in the cases a) ab) and b), it is advantageous if the plug element is in two parts in the manner indicated above; this will become clear further below.

In alternative a) aa), the counter ribs are preferably designed in the form of cylinder segments, each of which has an indentation on its bottom side, which is formed in such a manner that
a) a horizontal, circumferential surface remains radially on the outside of the bottom of the respective cylinder segment;
   or
b) the surface of the indentation merges radially on the outside into the inner shell surface of the support sleeve.

A design in which the plug element and the support element cannot be moved relative to each other in the functional configuration can be advantageously implemented by the plug element having an external thread at its bottom end and the support sleeve having a complementary internal thread in its coupling region.

Such a design, in which the plug element and the support element cannot be moved relative to each other in the functional configuration, can also be advantageously achieved with an alternative variant in relation to the plug element, in which the head section is again designed as a separate head part and the shaft section as a shaft part, which are detachably connected to one another by means of a connection, in particular by means of a threaded connection, but in which the shaft part is integrally connected to the support element at its bottom end so that a support/shaft element is formed which comprises the support element and the shaft part in one piece.

As explained above, in the tiered rack, the support element of a support unit usually rests on the head section of the plug element of the support unit therebelow. Alternatively, it can be advantageous for the support sleeve to have a lower section with an inner diameter and a cross-section which are adapted to the outer diameter and the cross-section of the head section of the plug element in such a manner that a support element can be guided from above over the head section of the plug element of a downwardly adjacent support unit so that the support element receives and surrounds this adjacent head section. Being under load in the tiered rack, a support element then carries the carrier plate assigned to it in the tiered unit and in turn rests on the carrier plate of the tiered unit arranged therebelow. This is particularly favorable in cases where the plug element and the support element are not movable relative to each other in the functional configuration.

The aforementioned object is achieved with a tiered unit of the type mentioned at the beginning in that the support units are designed with some, multiple, or all of the possible features explained above.

The aforementioned object is achieved with a tiered rack of the type mentioned at the beginning in that the tiered units are each such a tiered unit.

### BRIEF DESCRIPTION OF THE DRAWINGS

In the following, exemplary embodiments of the invention are explained in more detail with reference to the drawings. In the figures:

FIG. 1 shows a front view of a tiered rack for the heat treatment of workpieces, in which multiple tiered units, each consisting of one carrier plate and multiple support units, are stacked on top of each other;

FIG. 2 shows a detailed view of a corner region of the tiered rack;

FIG. 3 shows a front view of the tiered rack in which the uppermost tiered unit is lifted off and shown in a transport phase in which the tiered unit is moved separately and in which the support units are in an unloaded functional configuration;

FIG. 4 shows a front view of the tiered unit, in which the mobility of the carrier plate and the support units in relation to each other is illustrated when the support units are in an unloaded functional configuration;

FIG. 5 shows a one-piece plug element and a support element of a support unit according to a first exemplary embodiment;

FIG. 6 shows partial sections of a tiered unit with the support unit according to FIG. 5 in the rack assembly;

FIG. 7 shows partial sections of the tiered unit with the support unit according to FIG. 5 in a transport phase;

FIG. 8 shows a one-piece plug element and a support element of a support unit according to a second exemplary embodiment;

FIG. 9 shows partial sections of a tiered unit with the support unit according to FIG. 8 in the rack assembly;

FIG. 10 shows various partial sections of the tiered unit with the support unit according to FIG. 8 in a transport phase;

FIG. 11 shows a two-part plug element consisting of a head part and a shaft part as well as a support element of a support unit according to a third exemplary embodiment;

FIG. 12 shows partial sections of a tiered unit with the support unit according to FIG. 11 in the rack assembly;

FIG. 13 shows partial sections of the tiered unit with the support unit according to FIG. 11 in a transport phase;

FIG. 14 shows a two-part plug element consisting of a head part and a shaft part as well as a support element of a support unit according to a fourth exemplary embodiment;

FIG. 15 shows partial sections of a tiered unit with the support unit according to FIG. 14 in the rack assembly;

FIG. 16 shows partial sections of the tiered unit with the support unit according to FIG. 14 in a transport phase;

FIG. 17 shows a two-part plug element consisting of a head part and a shaft part as well as a support element of a support unit according to a fifth exemplary embodiment;

FIG. 18 shows partial sections of a tiered unit with the support unit according to FIG. 17 in the rack assembly;

FIG. 19 shows various partial sections of the tiered unit with the support unit according to FIG. 17 in a transport phase;

FIG. 20 shows another one-piece plug element and a support element of a support unit according to a sixth exemplary embodiment;

FIG. 21 shows a partial section of a tiered unit with the support unit according to FIG. 20 in the rack assembly;

FIG. 22 shows a partial section of the tiered unit with the support unit according to FIG. 20 in a transport phase;

FIG. 23 shows a head part and a support/shaft element of a support unit according to a seventh exemplary embodiment;

FIG. 24 shows partial sections of a tiered unit with the support unit according to FIG. 23 in the rack assembly;

FIG. 25 shows partial sections of the tiered unit with the support unit according to FIG. 23 in a transport phase.

### DESCRIPTION OF PREFERRED EXEMPLARY EMBODIMENTS

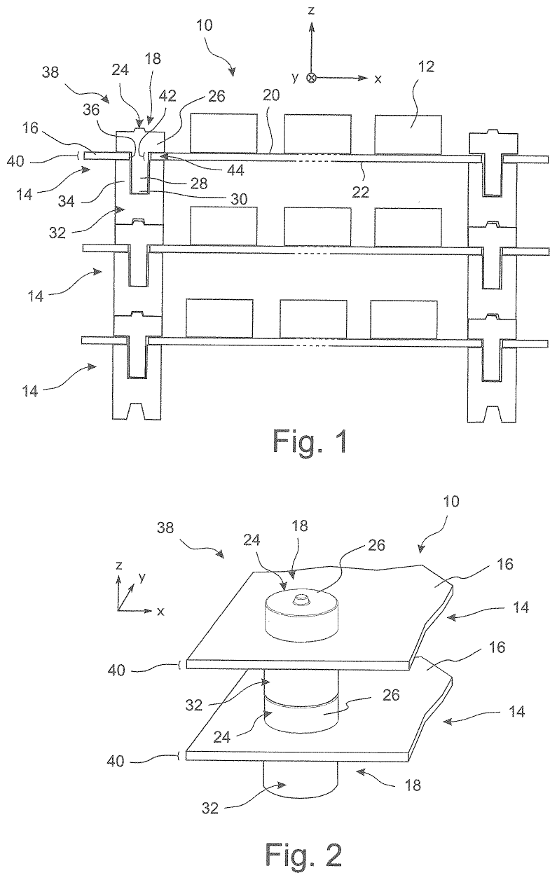

FIG. 1 shows a tiered rack, collectively indicated by 10, for the heat treatment of workpieces 12, which is used in particular for heat treatments at temperatures in excess of 1,000 ° C.

In the figures, reference coordinate systems are shown, each of which is to be anchored in a rotationally fixed manner to a component assigned to the reference coordinate system or to a construction consisting of multiple parts, so that they move in space together with the component or construction. In relation to the coordinate systems and taking into account the orientation of the tiered rack 10 and the tiered units 14 in kiln operation, the directional information used below means to the right is the positive x-direction, forward is the positive y-direction, and upward is the positive z-direction. The directions to the left, backwards and downwards each indicate the opposite direction. A vertical or a vertical plane thus runs in the z-direction and a horizontal or a horizontal plane thus runs in an xy-plane. For the sake of clarity, not all parts and components are marked with a reference sign in the figures.

The tiered rack 10 comprises multiple detachably stacked tiered units 14, three of which are shown in FIG. 1, wherein the components explained below are only provided with reference signs for the uppermost tiered rack 14 there. Each tiered rack 14 comprises in each case one carrier plate 16 and multiple support units 18. The carrier plate 16 defines an upper side or carrying side 20 and a lower side or supporting side 22. Each support unit 18 in turn comprises a plug element 24 which defines a head section 26 and a shaft section 28 projecting from the head section 26 with a bottom end 30 at a distance from the head section 26. In addition, each support unit 18 comprises a support element 32 which is connected to the bottom end 30 of the shaft section 28.

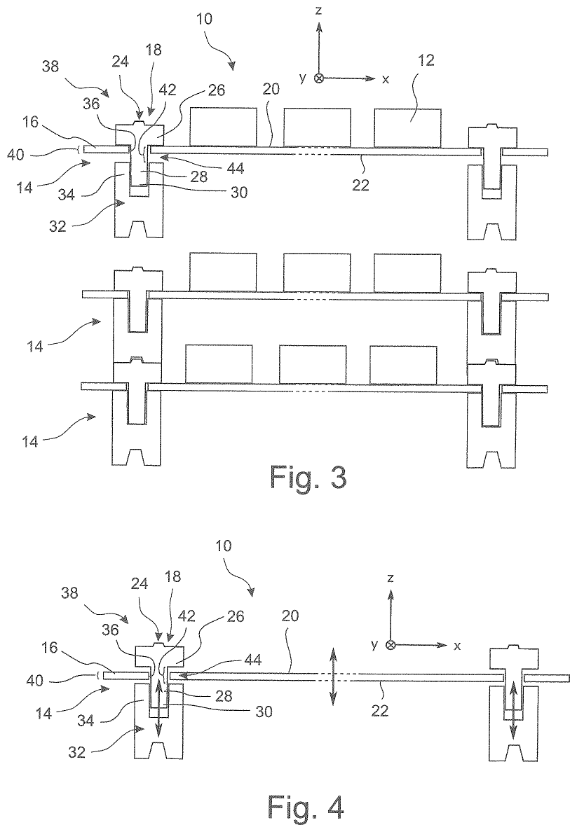

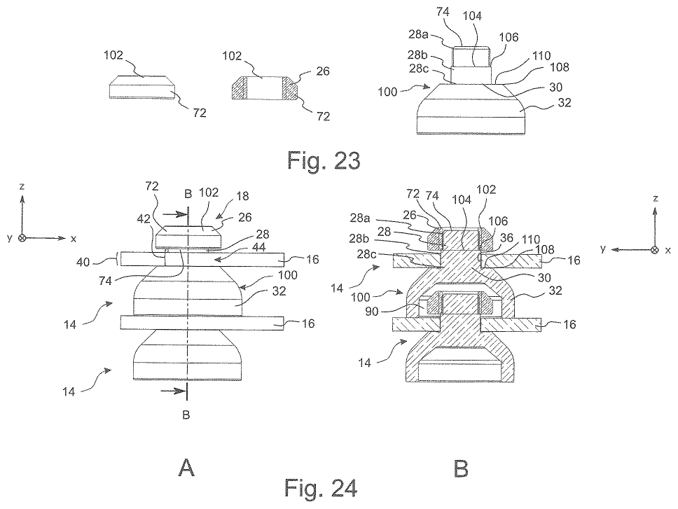

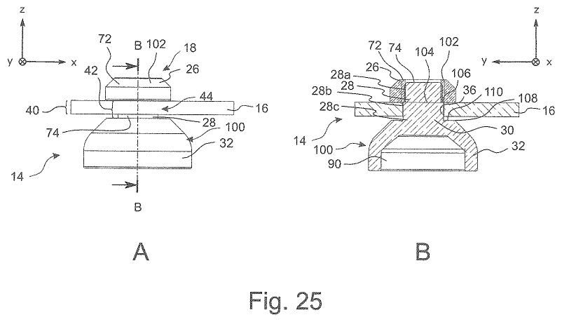

FIGS. 1 to 22 illustrate exemplary embodiments in which the support element 32 has a coupling region 34 that is complementary to the bottom end 30 of the shaft section 28. However, in a modification described further below with reference to the exemplary embodiment according to FIGS. 23 to 25, the support element 32 can also be integrally connected to the shaft section 28. The workpieces 12 will be or are positioned on the supporting side 20 of the carrier plate 16, which rests with its supporting side 22 on the support element 32 of the support unit 18 when the tiered unit 14 is set up. In doing so, the tiered units 14 can be stacked on top of one another in such a way that a spacing remains between two adjacent carrier plates 16 of the tiered rack 10 by detachably placing the support units 18 on top of one another. FIGS. 1 and 3 show a tiered rack 10 with only three tiered units 14; in practice, a tiered rack 10 may well comprise ten or more tiered units 14.

In order to ensure a sufficiently stable construction for the tiered rack 10, each carrier plate 16 must cooperate with at least three support units 18; the shape of the carrier plate 16 can in principle be arbitrary and may also depend on the geometry of the firing chamber of a kiln to be used. In a connection region in which the carrier plate 16 is to cooperate with a support unit 18, the carrier plate 16 has a plate through-opening 36 with a vertical through-axis and defines a plate thickness 40. In these connection regions, the carrier plate 16 may have a different thickness than in the regions in which the workpieces 12 are placed.

In the present exemplary embodiments, the carrier plate 16 of the tiered unit 14 is rectangular and has a plate through-opening 36 in each of its four corner regions 38; a support unit 18 is arranged there in each case. FIG. 2 illustrates corner regions 38 in a perspective view of two tiered units 14 placed on top of each other.

As explained at the beginning, a tiered unit 14 is moved by a robot for the assembly or disassembly of the tiered rack 10 in a transport phase, which robot engages on the carrier plate 16 for this purpose. FIG. 3 illustrates such a transport phase in which the uppermost tiered unit 14 loaded with workpieces 12 is detached from the two tiered units 14 already stacked on top of each other.

Each support unit 18 of a tiered unit 14 can now be connected to the carrier plate 16 in such a manner that the carrier plate 16 carries the respective support unit 18 along during such a movement or any other movement.

For this purpose, the head section 26 of the plug element 24 is designed in such a way that, due to its shape, it cannot pass through the plate through-opening 36 of the carrier plate 16; the shaft section 28, on the other hand, is complementary to the plate through-opening 32 in such a manner that it can pass therethrough. In the tiered unit 14, the head section 26 is located on the carrying side 20 of the carrier plate 16, with the shaft section 28 extending downwards through the plate through-opening 32 so that its bottom end 30 is located below the carrier plate 16. The support element 34 of the support unit 18 is also located below the carrier plate 16 in the tiered unit 14 and is coupled to the bottom end 30 of the plug element 24 via its coupling region 34.

In principle, the support unit 18 can be subjected to two main states when in use, namely a load state, in which the support element 32 of the support unit 18 directly absorbs a load and transfers this load downwards, and an unloaded state, in which no load acts on the support element 32 of the support unit 18.

In a tiered rack 10, as illustrated in FIG. 1, or in the case of the two lower tiered units 14 in FIG. 2, the tiered units 14 are located in a rack assembly and the support units 18 of the tiered units 14 there each assume a load state. Generally speaking, the load state of the tiered unit 14 is defined by the fact that the respective carrier plate 16 of the tiered unit 14 rests on the support elements 32 of the support units 18. In principle, the support units 18 already assume such a load state in the case of a tiered unit 14 that is individually and separately positioned in this way, without having to carry workpieces 12.

A transport phase explained above is an example of a situation in which the support unit 18 of the tiered unit 14 is in an unloaded state in which no load acts on the support element 32 of a support unit 14.

When a plug element 24 is functionally coupled to a support element 32, the support unit 18 defines a functional configuration. This configuration can be assumed by an isolated support unit 18, but is in particular present when a tiered unit 14 is formed from a carrier plate 16 and support units 18.

In this functional configuration of the support unit 18, the plug element 24 is coupled to the support element 32 in such a manner that between the head section 26 of the plug element 24 and the support element 32, a spacing 42 and a receiving region 44 remain in which the carrier plate 16 can be arranged between the head section 26 and the support element 32 or is arranged in a tiered unit 14. It should be emphasized again that this functional configuration is also assumed by a support unit 14 as such, i.e. without it being part of a tiered unit 14.

The above-described load state of a support unit 18 defines a loaded functional configuration, and the above-described unloaded state of a support unit 18 defines an unloaded functional configuration.

In the support unit 18 described here, the plug element 24 and the support element 32 are coupled to one another according to the invention in such a manner that, in the unloaded functional configuration of the support unit 18, the plug element 24 and the support element 32 can move relative to one another and/or, in the case of a tiered unit 14, relative to the carrier plate 18.

The resulting possible freedom of movement in a tiered unit 14 in an unloaded functional configuration in a tiered unit 14 are illustrated schematically in FIG. 4 using the double arrows shown there.

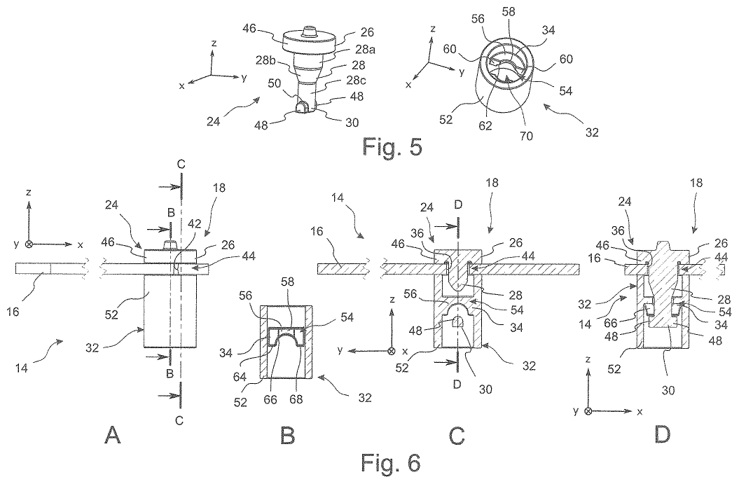

If the plug element 24 and the support element 32 can be moved relative to one another in an isolated support unit 18 according to the first alternative, this means that in the case of a tiered unit 14, each of the plug element 24 and the support element 32 can also be moved relative to the carrier plate 16 of the tiered unit 14. This is described below on the basis of the exemplary embodiments according to FIGS. 5 to 19. In FIG. 4, each of the double arrows shown on the support units 14 then refer separately to the associated plug element 24 and the support element 32.

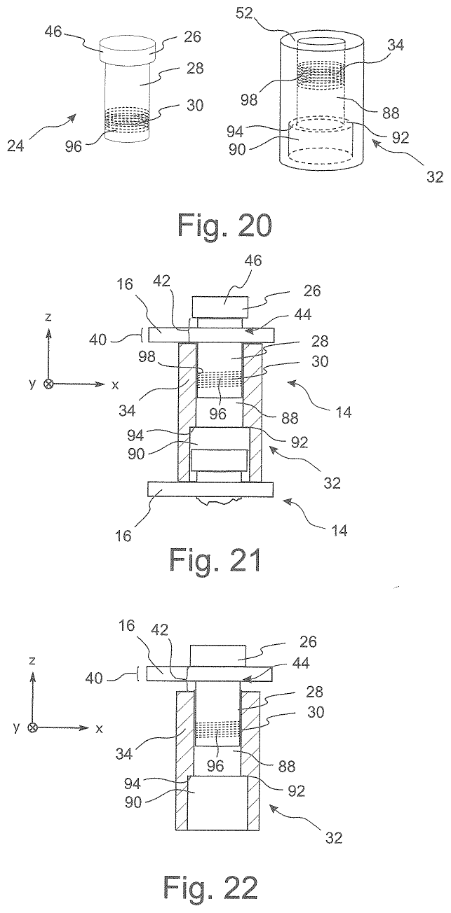

The second alternative, in which the plug element 24 and the support element 32 of a tiered unit 14 can be moved relative to the carrier plate 16 of the tiered unit 14, can also be implemented if the plug element 24 and the support element 32 cannot be moved relative to one another. In this case, for example, the spacing 42 between the head section 26 of the plug element 24 and the support element 32 is greater than the plate thickness 40 in their connection region. This will be explained again below by means of the exemplary embodiment according to FIGS. 20 to 22. In FIG. 4, the double arrows shown on the support units 14 thus only refer to the respective support unit 14 as a whole.

FIGS. 5 to 7 now illustrate a first exemplary embodiment of the support unit 18, in which the plug element 24 is formed in one piece.

The head section 26 is formed as a head disc 46 and, in the present exemplary embodiment, has an upward-pointing coaxial projection, which is not specifically designated, and which can serve as a radial securing means and, if necessary, as a centering guide for a support element 32 of an adjacent tiered unit 14, which is placed onto the underlying plug element 24.

At the bottom end 30, the plug element 24 has coupling pins 48 projecting to the right and to the left, respectively, i.e. in opposite directions transverse to its longitudinal axis, with a top side 50, which is curved here and has a cross-section in the shape of a semicircle. However, another design of the top side 50 is possible.

The shaft section 28 has, from top to bottom, an upper region 28a, a middle region 28b and a lower region 28c. In the present exemplary embodiment, the shaft section 28 tapers from top to bottom, with the coupling pins 48 extending in the radial direction so far that they are aligned with the region having the larger cross-section of the shaft section 28. In the present case, the upper region 28a has the largest cross-section, the middle area 28b then tapers downwards and merges into the lower region 28c with the smallest cross-section, which comprises the bottom end 30 and carries the coupling pins 48.

The support element 32 in the form of a hollow cylinder is designed as a support sleeve 52, the diameter of which is adapted to the head disc 46 in such a way that the support sleeve 52 can be placed onto a head disc 46 of an adjacent support unit 18. In its coupling region 34, the support element 32 has a counter device 54 which generally cooperates with the bottom end 30 of the plug element 24 and specifically, in the exemplary embodiment shown here, with the coupling pins 48 of the plug element 24, in such a manner that the bottom end 30 of the plug element 24 carries the support element 32 along during a movement. The bottom end 30 of the plug element 24 then serves, as it were, as a driver for the support element 32.

In the present exemplary embodiment, two opposing counter ribs in the form of cylinder segments 56 are formed on the right and left on the inner shell surface of the supporting sleeve 52, which project horizontally inwards and define an inner radius 58 and free end surfaces 60, which run vertically here. The inner radius 58 is selected such, and the cylinder segments 56 are spaced and positioned in the circumferential direction such that the coupling pins 48 of the plug element 24 can be passed through between the opposing end surfaces 60 of two adjacent cylinder segments 56 when the coupling pins 48 point to the left or right. In the present case, the inner radius 56 of the cylinder segments 56 is complementary to the lower area 28c of the plug element 24.

In a modification not specifically shown, the opposing end surfaces of two adjacent cylinder segments 56 can be curved in such a manner that a kind of threaded through-opening is formed and the coupling pins 48 of the plug element 24 can only be passed through between the cylinder segments 56 with a superposition of a vertical movement and a rotation about the longitudinal axis of the plug element 24.

On the bottom side, each cylinder segment 56 also has an indentation 62, wherein radially on the outside of the bottom side of the cylinder segment 56, a horizontal circumferential surface 64 remains, which has a reference sign only in FIG. 6B.

In the present case, the indentations 62 each provide guide surfaces 66 which are inclined from bottom to top and from radially outside to inside and which, for the sake of clarity, only have a reference sign in FIGS. 6B and 6D and, in the present exemplary embodiment, correspond to the surface of a hemispherical segment and consequently have a curvature. As can be seen in particular in FIG. 6B, the radius of these hemispherical segments is larger than the inner radius 58 of the cylindrical segment 56, but smaller than the inner radius of the support sleeve 52 so that a horizontal annular surface section 68, designated only in FIG. 6B, is formed on the bottom side of each of the cylindrical segments 56. In the case of the support element 32, the guide surfaces 66 of the two cylinder segments 56 describe surface segments of a common hemisphere.

The plug element 24 or its coupling pins 48 are adapted to the cylinder segments 56 in such a way that, viewed in the radial direction, the coupling pins 48 end before the annular surface sections 68 begin. In addition, the shaft section 28 of the plug element 24 is so long that the coupling pins 48 are located below the cylinder segments 56 in the load state of the support unit 18.

When assembling a tiered unit 14, a plug element 24 is inserted, bottom end 30 first, from the carrying side 20 of the carrier plate 16 through a plate through-opening 36. Then, a support element 32, with the indentations 62 pointing downwards, is guided on the supporting side 22 of the carrier plate 16 over the plug element 24 in such a way that its coupling pins 48 are passed through between the cylinder segments 56 and come to lie below the cylinder segments 56. The support element 32 is then rotated by 90°about its longitudinal axis so that the cylinder segments 56 come to lie overlapping above the coupling pins 48 and the right and left sides of the plug element 24 and the support element 32 point in the same direction; this configuration can be clearly seen in FIG. 6C, for example.

In the loaded functional configuration of the support units 18, the carrier plate 16 now rests with its supporting side 22 on the support element 32, and the head disc 46 of the plug element 24 rests on the carrying side 20 of the carrier plate 16. As explained above, the coupling pins 48 are located below the counter device 54.

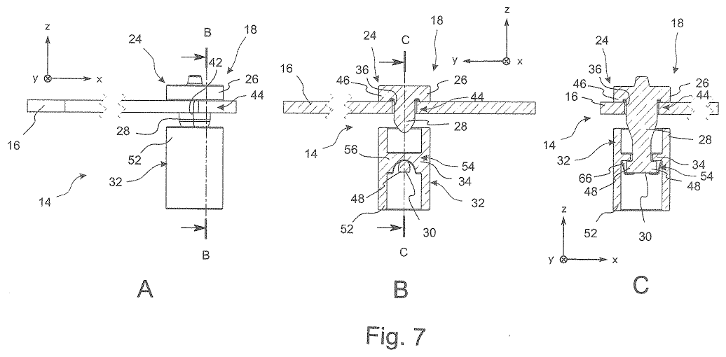

When the tiered unit 14 is now transferred from the load state to an unloaded state, for example by a handling robot gripping the carrier plate 16 and detaching the tiered unit 14 from the rack assembly in the tiered rack 10, the carrier plate 16 first lifts off the support elements 32 of the existing support units 18. In doing so, the respective plug element 24 is also moved upwards, wherein the coupling pins 48 of the plug elements 24 move upwards into the indentations 62 of the counter device 54, i.e., the cylinder segments 56, and finally abut against the cylinder segments 56. This situation is illustrated in FIG. 7A, B, C, D.

During a further upward movement of the tiered unit 14, the support element 32 is now pulled upwards by the coupling pins 56 of the plug element 24 and the support unit 18 moves in this configuration together with the carrier plate 16.

Due to the curved top side 50 of the coupling pins 48 of the plug element 24 in interaction with the indentations 62 or the guide surfaces 66 of the counter device 54, a safety device 70 is also established, by means of which it is ensured in a sufficiently reliable manner that the plug element 24 remains connected to the support element 32 when it is transferred from the load state to the unloaded state and when it is in the unloaded state.

For example, it can happen in the tiered rack 10 in which a tiered unit 14 is located in the rack assembly, that the support element 32 gets twisted with respect to the plug element 24 so that the right and left sides of the plug element 24 no longer point in the direction of the right and left sides of the support element 32, respectively. However, if a plug element 24 is then initially moved upwards relative to the support element 32, the top sides 50 of the coupling pins 48 reach the guide surfaces 66 of the counter device 54 of the support element 32. Due to their upwardly and inwardly inclined design, the weight force causes a kind of forced guidance or forced rotation of the support element 32 and the plug element 24 relative to one another, whereby the two components are forced into their carry-along configuration explained above.

In the design with the curved end surfaces 60 explained above, which is not shown, the safety effect of the safety device 70 is further increased.

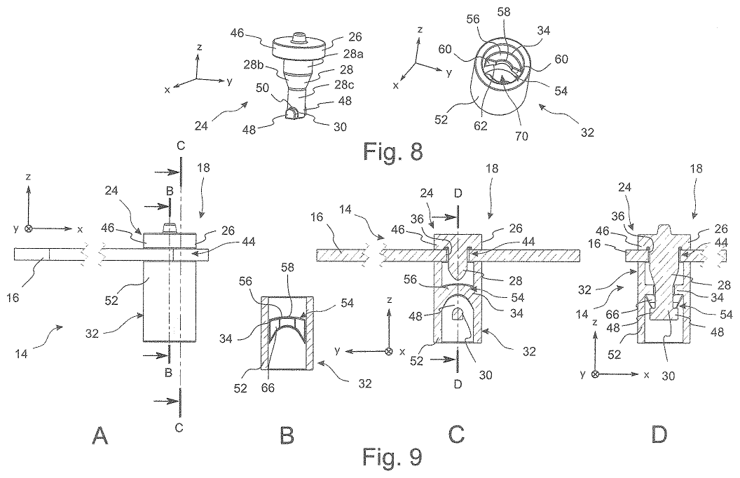

FIGS. 8 to 10 illustrate a second exemplary embodiment of the support unit 18, in which the plug element 24 is formed in one piece. Here, the support unit 18 differs from the support unit 18 according to the first exemplary embodiment according to FIGS. 5 to 7 only by a modification of the counter device 54.

Here, the indentation 62 is formed in such a way that there is no longer a circumferential horizontal surface on the bottom side of the cylinder segments 56. The guide surface 66 of the indentation 62 merges seamlessly, so to speak, into the inner shell surface of the support sleeve 52 on the radial outside, which can be clearly seen in FIGS. 9B and 9C.

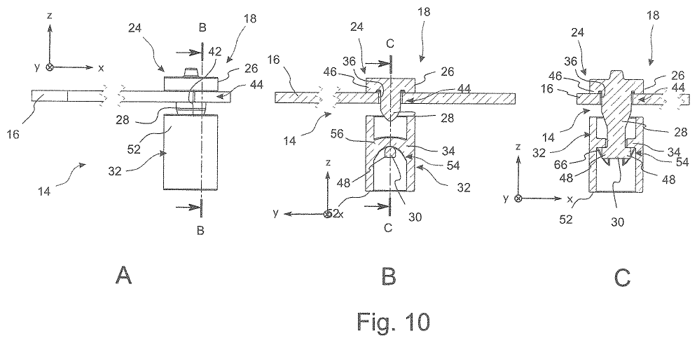

In this manner, it is ensured even more reliably that the coupling pins 48 of the plug element 24 abut with their top side 50 against the guide surfaces 66 when a tiered unit 14 is lifted, and the plug element 24 and the support element 32 assume their carry-along configuration, which is illustrated in FIGS. 10A, 10B and 10C.

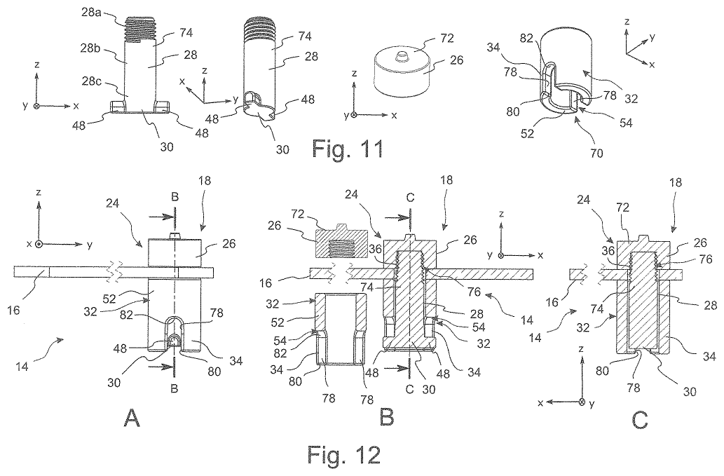

FIGS. 11 to 13 illustrate a third exemplary embodiment of the support unit 18, in which, however, the plug element 24 is formed in two parts. The head section 26 is formed as a separate head part 72 and the shaft section 28 is formed as a separate shaft part 74. The head part 72 and the shaft part 74 can be detachably connected to one another, for which purpose a connection 76 is provided, which in the present exemplary embodiment is a threaded connection. In the present exemplary embodiment, the head part 72 has a threaded sleeve and the shaft part 74 has a complementary external thread at its upper region 28a; these components can also be interchanged. In a modification not specifically shown, a different connection can also be formed, for example in the manner of a bayonet lock.

The shaft part 74—and thus the shaft section 28—has a constant cross-section along its longitudinal axis in the regions 28a, 28b, and 28c.

The counter device 54 of the support element 32 is formed by two vertical guide slots 78 in the support sleeve 52, which extend in the wall thereof from a lower, open end 80 to an upper stop end 82 opposite each other on the right and left side of the support sleeve 52. The width of the guide slots 78 is complementary to the width of the coupling pins 48 on the plug element 24.

When assembling a tiered unit 14, the support element 32 is now arranged on the supporting side 22 of the carrier plate 16 in such a way that the open ends 80 of the guide slots 78 point downwards.

The shaft part 74 is then inserted into the support sleeve 52 from below, with its bottom end 30 pointing downwards, and the coupling pins 48 are inserted into the guide slots 78 of the support element 32.

The upper connecting end of the shaft part 74 is pushed from below through the plate through-opening 36 of the carrier plate 16, and the head part 72 is connected to the plug part 74 on the carrying side 20 of the carrier plate.

In the loaded functional configuration, the carrier plate 16 again rests on the support element 32 and the head part 72 rests on the carrier plate 16; the corresponding support element 32 of an upwardly adjacent support unit 18 rests on the head part 72. The length of the plug part 74 is adapted in such a way that in the load state, the coupling pins 48 are arranged between the lower open end 80 and the upper stop end 82 of the guide slots 78; this is shown in FIGS. 12A, 12B, and 12C.

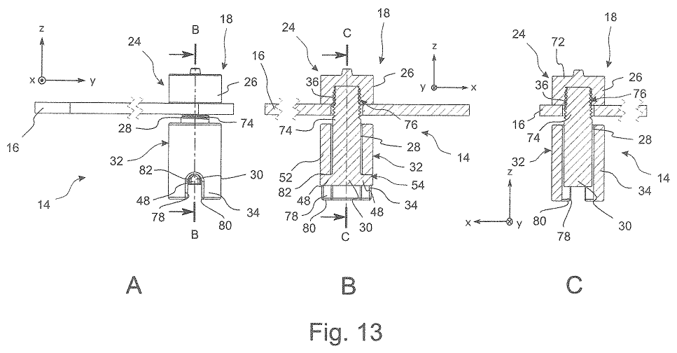

When the tiered unit 18 is now transferred to the unloaded state in a transport phase and the support unit 18 is thereby transferred to an unloaded functional configuration, the support element 32 can slide downwards until the stop ends 82 of the guide slots 78 reach the coupling pins 48 of the shaft part 74, which then support the support element 32; this can be seen in FIGS. 13A, 13B, and 13C.

The safety device 70 is implemented here by the interaction of the coupling pins 48 with the guide slots 78.

In a modification, three or more coupling pins 48 can also be present on the plug element 24, in which case a corresponding number of guide slots 78 is present in a corresponding arrangement.

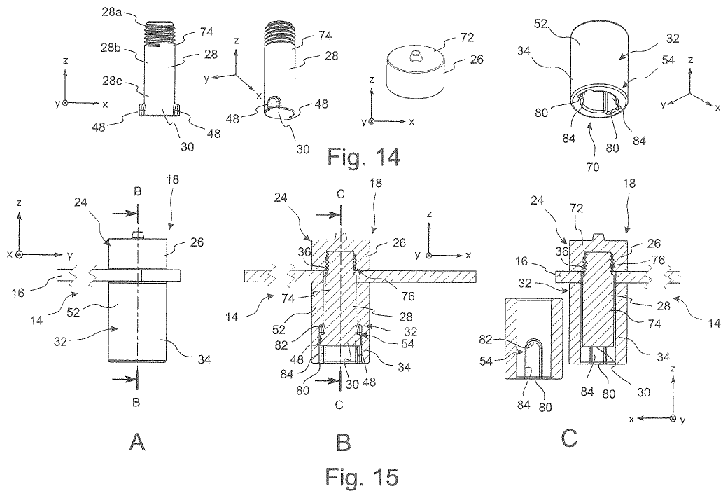

FIGS. 14 to 16 illustrate a fourth exemplary embodiment of the support unit 18, in which the plug element 24 is again formed in two parts. This support unit 18 differs from the support unit 18 of the third exemplary embodiment according to FIGS. 11 to 13 in two aspects.

On the one hand, instead of the guide slots in the support element 32, guide slots 84 are formed in the counter device 54, but these guide slots also have a lower open end 80 and an upper stop end 82. On the other hand, the extent of the coupling pins 48 on the shaft part 74 is adapted such that the coupling pins 48 can be inserted into the guide grooves 84 from below.

The assembly of a tiered unit 14 is carried out as described above for the third exemplary embodiment, with the coupling pins 48 accordingly being arranged in the guide grooves 84.

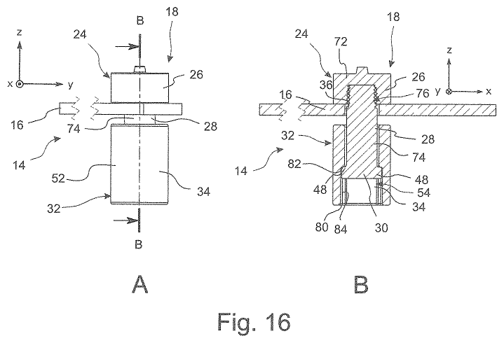

FIGS. 15A, 15B, and 15C illustrate the load state in which the coupling pins 48 are correspondingly positioned between the open end 80 and the stop end 82 of the guide grooves 84. FIGS. 16A and 16B show the unloaded state in a transport phase, in which the support element 32 rests with the stop ends 82 of the guide grooves 84 on the coupling pins 48.

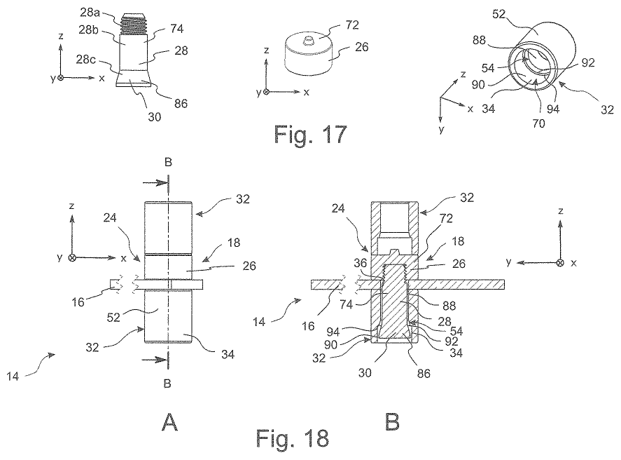

FIGS. 17 to 19 illustrate a fifth exemplary embodiment of the support unit 18, in which the plug element 24 is also formed in two parts. In contrast to the exemplary embodiments explained so far, the bottom end 30 of the shaft part 74 does not have any coupling pins here; rather, the lower region 28c of the shaft section 28 forms the bottom end 30 and is formed as a coupling collar which here specifically forms a coupling cone 86 that widens downwards starting from the middle region 28b. The upper region 28a and the middle region 28b have an identical constant cross-section, at least in the design shown.

In a modification not shown, for example, the lower region 28c can also have a constant cross-section and bear a circumferential rib as a collar at the bottom end 30.

The inner shell surface of the support sleeve 52 is stepped and has an upper section 88 and a lower sleeve section 90 with a larger inner diameter in comparison, so that between the section 88 and the sleeve section 90, the counter unit 54 is formed by a circumferential step 92 with a downwardly facing stepped surface 94 which is complementary to the coupling collar, i.e., the coupling cone 86. Here, the upper section 88 has an inner diameter complementary to the upper regions 28a, 28b of the shaft part 74, whereas the inner diameter of the lower sleeve section 90 is adapted to the coupling cone 86 of the shaft part 74. In the present exemplary embodiment, an upwardly tapering cone section is also formed between the upper section 88 and the lower sleeve section 90; however, this need not be the case.

When assembling the tiered unit 14, here too, the shaft part 74 is guided from below through the support sleeve 52 until the shaft part 74 projects through the plate through-opening 36 onto the carrying side 20 of the carrier plate 16, where it is connected to the head part 72 by means of the threaded connection 76.

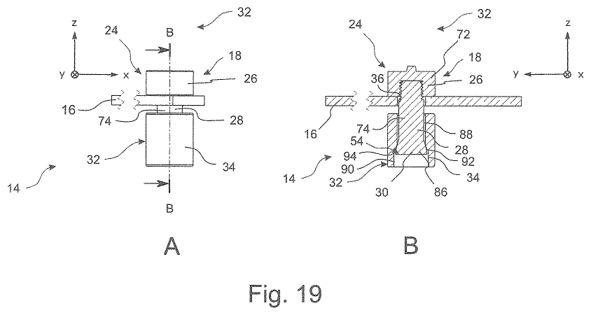

In the load state shown in FIGS. 18A, 18B, a spacing remains between the step 92 and the shaft part 74. As FIGS. 19A and 19B illustrate, the support sleeve 52 can slide downwards in the unloaded state until the step 92 rests on the coupling cone 86.

FIGS. 20 to 22 show a sixth exemplary embodiment of the support unit 18, which implements the alternative described above that the plug element 24 and the support element 32 are not movable relative to each other, wherein the spacing 42 between the head section 26 of the plug element 24 and the support element 32 is greater than the plate thickness 40.

For this purpose, the plug element 24, which is again in one piece here, is provided with an external thread 96 at its bottom end 30, while the support element 32 is provided with a complementary internal thread 98 in its coupling region 34. The bottom end 30 and the coupling region 34 of the support element 32 can also be designed alternatively and, for example, again form a type of bayonet lock.

Here too, the support sleeve 52 is formed with an upper section 88 and a lower, downwardly open sleeve section 90 and a step 92, with no conical section extending therebetween. The inner diameter and cross-section of the lower sleeve section 90 of the support element 32 and the outer diameter and cross-section of the head section 26 of the plug element 24 are matched such that a support element 32 can be guided from above over the head section 26 of the plug element 24 of a downwardly adjacent support unit 18 so that the support element 32 receives and surrounds this adjacent head section 26. This is illustrated in FIG. 21, which shows the load state and the loaded functional configuration of the support unit 18.

In all five exemplary embodiments explained so far, the support sleeve 52 of a support unit 18 rests in the load state in the downward direction on the head section 26 of the plug element 24 of a downwardly adjacent support unit 18.

Deviating from this, in the sixth exemplary embodiment, the support sleeve 52 rests in the load state of a tiered rack 10 directly on the underlying carrier plate 16 of an associated tiered unit 14.

This concept can be implemented in principle, for which purpose the outer diameter of the head section 26 of the plug element 24 and the inner diameter of the support element 32 in its lower end must be matched accordingly in the first five exemplary embodiments.

In the sixth exemplary embodiment according to FIGS. 19 to 21, assembling the tiered unit 14 is now carried out in such a manner that the plug element 24 is guided, bottom end 30 first, from above through the plate through-opening 32 of the carrier plate 16 and into the support sleeve 52 located below, to which it is then screwed accordingly.

In the load state, the carrier plate 16 rests on the support sleeve 52 wherein, however, a spacing remains between the carrier plate 16 and the head section 26 in the upward direction, which corresponds to the difference between the spacing 42 and the plate thickness 40.

When the tiered unit 14 is brought into the unloaded state, the support unit 18 in the unloaded functional configuration drops downwards with respect to the carrier plate 16 until the head section 26 of the plug element 24 rests on the carrying side 20 of the carrier plate 16. A spacing then remains between the carrier plate 16 and the support element 32 in the downward direction, which again corresponds to the difference between the spacing 42 and the plate thickness 40. This is shown in FIG. 22.

Finally, FIGS. 23 to 25 show, as a modification, a seventh exemplary embodiment of the support unit 18 which also implements that the plug element 24 and the support element 32 are not movable relative to each other, wherein the spacing 42 between the head section 26 of the plug element 24 and the support element 32 is greater than the plate thickness 40.

For this purpose, in this exemplary embodiment, the shaft part 74 is integrally connected at its bottom end 30 to the support element 32, so that a support/shaft element 100 is formed which comprises the support element 32 and the shaft part 74 of the plug element 24 in one piece.

The head part 72 is present separately and is formed as an axially continuous head ring 102 with an internal thread which is complementary to an external thread in the upper region 28a of the shaft part 74, whereby the connection 76 is or can be established. Here too, in a modification not specifically shown, a different connection 76 can be formed, for example in the manner of a bayonet lock. Furthermore, as in the other exemplary embodiments, the top side of the head portion 72 can be closed.

The upper region 28a of the shaft part 74 merges into the middle region 28b via a circumferential clamping step 104 having an upwardly pointing step surface 106; the lower region 28c with the bottom end 30 has the same cross-section as the middle region 28b in the present exemplary embodiment. The head ring 102 can be screwed against the clamping step 104 and thereby clamped in place.

At the transition between the shaft part 74 and the support element 32, the support/shaft element 100a is formed with a circumferential bearing step 108 having a bearing step surface 110 on which the carrier plate 16 can rest.

The axial extent of the sections 28b and 28c of the shaft part 74 from the clamping step 104 to its bottom end 30 or to the support element 32 corresponds to the spacing 42 and the receiving region 44 of the support unit 18.

The support element 32 is not formed as a support sleeve; however it also has a downwardly open sleeve section 90 which, however, is closed in the upward direction. The term sleeve section here merely means that in this section, there is a circumferential wall that surrounds an interior space.

Here too, the inner diameter and cross-section of the sleeve section 90 are matched to the outer diameter and cross-section of the head section 26 of the plug element 24, in this case to the head ring 102: a support element 32, in this case the support/shaft element 100, can be guided from above over the head section 26 of the plug element 24 of a downwardly adjacent support unit 18 so that the support element 32 receives and surrounds this adjacent head section 26. This is illustrated in FIG. 24, which shows the load state and the loaded functional configuration of the support unit 18.

Thus, as in the sixth exemplary embodiment, the support element 32 in the seventh exemplary embodiment also rests in the load state of a tiered rack 10 directly on the underlying carrier plate 16 of an associated tiered unit 14.

In the exemplary embodiment shown here, the support element 32 of the support/shaft element 100 has a kind of bell shape. However, the geometry of the support element 32 can deviate therefrom and, for example, can also be formed in the manner of a cylinder. The support element 32 can also be longer in the axial direction than in the exemplary embodiment shown here. This applies in principle to all exemplary embodiments described: the length of the support element 32 is in each case adapted to the size of the spacing needed between two adjacent carrier plates 16 in the tiered rack 10.

In the seventh exemplary embodiment according to FIGS. 22 to 24, assembling the tiered unit 14 is carried out in such a manner that the shaft part 74, with the upper region 28a leading, is guided from below through the plate through-opening 32 of the carrier plate 16. On the carrying side 20 of the carrier plate 16, the head part 72 is then screwed onto the shaft part 74 and clamped against the clamping step 104 thereof.

In the load state, the carrier plate 16 rests on the bearing step surface 110 of the support element 32, wherein again, a spacing remains between the carrier plate 16 and the head section 26 in the upward direction, which corresponds to the difference between the spacing 42 and the plate thickness 40.

When the tiered unit 14 is brought into the unloaded state, the support unit 18 in the unloaded functional configuration drops downwards with respect to the carrier plate 16 until the head section 26 of the plug element 24, i.e., in the present exemplary embodiment the head section 72 in the form of the head ring 102, rests on the carrying side 20 of the carrier plate 16. A spacing then remains between the carrier plate 16 and the support element 32 in the downward direction, which again corresponds to the difference between the spacing 42 and the plate thickness 40. This can be seen in FIG. 24.

What is claimed is:

1. A support unit for a carrier plate for the construction of a tiered rack for the heat treatment of workpieces, wherein the carrier plate, along with a plurality of support units, forms a tiered unit and has multiple plate through-openings, wherein a respective support unit can be connected to the carrier plate in such a way that the carrier plate carries the respective support unit along in the event of a movement, comprising:
a) a plug element with a head section which cannot pass through the a plate through-opening due to its shape, and with a shaft section which projects from the head section and which is complementary to the plate through-opening in such a way that it can pass therethrough, and which has a bottom end at a distance from the head section;
b) a support element which is connected to the bottom end of the shaft section;
wherein
c) in a functional configuration of the support unit between the head section of the plug element and the support element, a spacing and a receiving region remain in which a carrier plate can be arranged between the head section and the support element or where it is arranged in a tiered unit; further wherein
d) in the unloaded functional configuration of the support unit the plug element and the support element can be moved relative to one another and/or relative to the carrier plate in the case of a tiered unit.

2. The support unit according to claim 1, wherein the head section of the plug element is designed as a separate head part and the shaft section as a shaft part, which are detachably connected to one another by means of a connection.

3. The support unit according to claim 2, wherein the shaft part is designed as a separate shaft part which is also detachably connected to the support element.

4. The support unit according to claim 1, wherein wherein the support element is a support sleeve.

5. The support unit according to claim 4, wherein the support element has a counter device which cooperates with the bottom end of the plug element in such a manner that the bottom end of the plug element carries the support element along during a movement.

6. The support unit according to claim 5, wherein
a) the plug element carries at its bottom end at least two coupling pins projecting transverse to its longitudinal axis, wherein,
aa) the counter device of the support sleeve comprises counter ribs matching the coupling pins of the plug element, which counter ribs project inwards on the inner shell surface of the support sleeve and are spaced apart in the circumferential direction in such a manner that the coupling pins of the plug element can be passed through between the counter ribs; or
ab) the counter device of the support sleeve comprises guide slots or guide grooves which are complementary to the coupling pins of the plug element and extend in the wall of the support sleeve from an open end to a stop end and in which the coupling pins of the plug element are guided; or
b) the plug element forms a coupling collar, at its bottom end, and the counter device of the support sleeve is formed by a step complementary to the coupling collar and having a downwardly facing step surface in the inner shell surface of the support sleeve.

7. The support unit according to claim 6, wherein the counter ribs are designed in the form of cylinder segments which each have an indentation on their bottom side, which indentation is formed in such a manner that
a) a horizontal, circumferential surface remains radially on the outside of the bottom side of the respective cylinder segment;
or
b) the surface of the indentation merges radially on the outside into the inner shell surface of the support sleeve.

8. The support unit according to claim 4, wherein the plug element has an external thread at its bottom end and the support sleeve has an internal thread complementary thereto in a coupling region.

9. The support unit according to claim 2, wherein the shaft part is integrally connected to the support element at its bottom end so that a support/shaft element is formed which comprises the support element and the shaft part of the plug element in one piece.

10. The support unit according to claim 9, wherein the support element has a lower sleeve section with an inner diameter and a cross-section that are matched to the outer diameter and the cross-section of the head section of the plug element in such a way that a support element can be guided from above over the head section (26) of the plug element (24) of a downwardly adjacent support unit (18) so that the support element (32) receives and surrounds this adjacent head section (26).

11. A tiered unit for the construction of a tiered rack for the heat treatment of workpieces, comprising:
a carrier plate with multiple plate through-openings, wherein in each case one support unit is connected there to the carrier plate (16) in such a manner that the carrier plate carries the respective support unit along during a movement, wherein
the support units are designed according to claim 1.

12. A tiered rack for the heat treatment of workpieces, comprising:
multiple tiered units each having one carrier plate and multiple support units wherein the tiered units are each a tiered unit according to claim 11.

13. The support unit according to claim 1, wherein the support element has a counter device which cooperates with the bottom end of the plug element in such a manner that the bottom end of the plug element carries the support element along during a movement.
